(19) United States
(12) Patent Application Publication
(10) Pub. No.: US 2006/0118507 A1
(43) Pub. Date: Jun. 8, 2006

(54) Device and method for identifying containers personal to sighted and visually handicapped individuals

(76) Inventor: Brenda L. Feldman, Friendswood, TX (US)

Correspondence Address: DAVID W. ALEXANDER, 1989 Kingston Cove, League City, TX, 77573, US

(21) Appl. No.: 11/365,284

(22) Filed: Mar. 1, 2006

Related U.S. Application Data
(60) Provisional application No. 60/659,280, filed on Mar. 7, 2005.

(51) Int. Cl. A47J 41/02; B65D 45/04; B65D 23/10; B65D 85/00; B65D 23/00

(52) U.S. Cl. 215/12.1; 215/286; 215/396; 206/459.5

(57) ABSTRACT

A reusable water-proof elastomeric band embossed or debossed with alphanumeric characters and embossed with braille characters on the outer surface of the band, and on the inner surface if desired by the user, to represent the name of an individual, contents of the container, or any other useful information, and slipped tightly around a container of outside perimeter slightly larger than the inside circumference of the band, is disclosed as a device and method for labeling the container. Said alphanumeric and braille characters may be read by sighted and visually-handicapped individuals. Said device may be quickly and easily placed around or removed from a container without the use of tools. The labeling device and method is suitable for the short or long-term labeling of containers, water resistant, dishwasher safe, microwaveable, thermally sterilizable, and may be reused numerous times.

### CROSS-REFERENCE TO RELATED APPLICATIONS

This application claims priority of U.S. Provisional Application No. 60/659,280, filed Mar. 7, 2005, entitled: Device, system and method for identifying containers personal to sighted and visually handicapped individuals, by Brenda L. Feldman.

### STATEMENT REGARDING FEDERALLY SPONSORED RESEARCH OR DEVELOPMENT

Not applicable.

### MICROFICHE APPENDIX

Not applicable.

### BACKGROUND OF THE INVENTION

(1) Field of the Invention

This invention relates to a reusable water-proof elastomeric identification band for containers which are personal to a sighted or visually-handicapped individual. With the prevalent use of food, drink, and personal care items in day-care centers, schools, camps, or wherever children or adults congregate, there is a need for a means of quickly and easily associating the container with a particular child or adult. Also, it is well-known that visually-handicapped individuals wish to be accepted into mainstream society. Therefore, any device, system, and method for labeling containers personal to them should be available for their use. Further, any device for labeling containers should be durable, easy to read by the sighted and visually-handicapped, dish-washer proof, easily removable, and reusable. The invention described herein meets all of these needs.

(2) Background of the Invention

Heretofore, if a container is to be identified with the name of a particular child or adult, it is common practice to write that individual's name on the container or on a piece of tape affixed to such container. This practice, however, is disadvantageous in a number of respects. First, the writing may not be water-resistant and may be lost during washing, exposure to water in the bathroom or shower, or by routine use. If tape is used as the writing medium, it may be easily removed thereby defeating the purpose of labeling. Also, removing the tape may leave a sticky residue, ruining the container or impairing its use. Further, there may be situations where the container is desired to be temporarily labeled with an individual's name or moniker. Writing the name directly on the container with indelible ink defeats this purpose.

In the past, numerous methods and devices have been suggested and used to provide identification for containers which are to be used by specific children and adults. Identification of goods, including containers, personal to individuals are particularly needed for sighted and visually-handicapped infants, children and adults in group settings. Various types of identifiers for the goods of infants have included labels or tags sewn to the item of the infant with their pertinent information listed on the label or tag. Other devices have included bracelets worn on the wrist or ankle of the infant. Some of these personal labeling devices have been adapted to the labeling of containers. However, all of these devices have limitations which make them unsuitable for use by the visually-handicapped.

There remains a great need in the marketplace for an improved identification device, system and method for containers which overcomes the difficulties mentioned above. Specifically, the improved container identification device described herein may be manufactured without difficulty, made durable and water-resistant, pre-labeled with the individual's name in characters easily readable by the sighted and visually-handicapped, dish-washer proof, and easily removable and reusable.

(3) Description of the Related Art Including Information Disclosed Under 37 C.F.R. 1.97 and 1.98

Although U.S. patents or published patent applications are known which disclose various container labeling devices, systems and methods, none of them disclose labeling means which meet all of the needs described herein.

Brixus, et al., U.S. Pat. No. 2,976,629, discloses a ring member which may be placed around the neck of a bottle which has a separate plate member attached to the ring which serves as a decorative piece for easy identification. This device suffers from the drawback that it must be pre-designed and pre-manufactured to fit a particular container based on the container's shape where the ring is to be affixed or attached. Furthermore, due to the rigid nature of this device it is difficult for one to easily transport it to and from events and a separate carrying container would appear to be needed in order to protect the device when not in use. The ring and nameplate could easily become dislodged or fall away from the container, if the ring was not properly pre-designed to fit the container. For the visually handicapped, if the name plate was to be rotated upward from the point where it attaches to the ring, it might not be able to be read or may be read improperly due to misplacement of the braille dots.

Jung, et al., U.S. Pat. No. 4,171,864, discloses an identification document containing both visual data and invisible, or holographic data. The identification document may be a cheque card, a credit card, an identity document or any other document containing certain information for identifying a person or an object. Although it is an identification device, this invention is not intended to be used for the labeling of containers. Its primary function is for authentication of documents or other items personal to the holder, but not containers. Further, the labeling device consists of layers, each of which has a function; i.e., place for a signature, support for the visual data, holographic data, or protection from handling or the environment. The identification device disclosed in Jung, et al. is not designed to be so flexible that it could be formed to fit around a container nor to be resistant to repeated washes, for example in a dishwasher. Therefore, it does not meet the needs described in this application.

Ricks, U.S. Pat. No. 4,759,139, discloses a removable identification collar for baby bottles. The Ricks disclosure addressed the need for quickly and easily associating an infant's baby bottle with a particular infant. In the Ricks disclosure, a removable collar is placed over the neck of a baby bottle and the collar is fixed in place by a standard nipple cap. A flange provided on the collar receives a gummed label protected by a raised ridge of a portion of the flange, which prevents infants from readily removing the label. The infant's name is intended to be written on the gummed label by means of a pencil, pen, or other writing or lettering instrument. The gummed label is then meant to be affixed to the identification collar to identify a particular infant. The Ricks invention suffers from several limitations. It is designed to label baby bottles, which have a shape and structure well known to those in the arts regarding the design of containers used for bottle-feeding infants. Further, because the gummed label is intended to be paper, it is not suitable for repeated washes. For these reasons, the Ricks disclosure does not meet the needs addressed by the disclosure in this application.

Solon, U.S. Pat. No. 4,991,337, discloses a readily disposable identification bracelet for identifying young children when they are traveling alone or in groups, with limited supervision. The invention comprises an elongated strip of thin, but tough, flexible material having a place on one surface for writing, with a pencil, pen, typewriter or other writing instrument, information identifying the individual to whom the bracelet is to be affixed. Sections at the ends of the band contain pressure sensitive adhesive located on opposite sides. Once the identification band is labeled with the child's name and other personal identifying information, the band is stretched around the child's arm and engaged at the surfaces carrying the pressure sensitive adhesive. This invention is meant to identify an individual, not a container. Further, the ready disposable nature of this invention is not a desirable feature for a container identification means and method intended for identifying a container personal to a visually impaired individual, durable, and the pressure sensitive adhesive is not amenable to repeated washes in a dishwasher.

Evans, U.S. Pat. No. 5,358,770, discloses an identifying device which is releasably clamped around an object, such as a beverage container. This device suffers from drawbacks similar to the device disclosed by Brixus et al. It appears to be difficult to transport to and from a location without a separate container due to its bulky nature. Further, the semi-circular ring is not designed to completely surround the container to which it is affixed. It therefore will not fix itself securely to containers of a shape different than the shape of the semi-circular ring. The Evans invention suffers from the limitation that each identifying device must be pre-designed and pre-manufactured to fit the shape and circumference of the container it is to surround.

Groth, U.S. Pat. No. 5,704,144, discloses a beverage container identification tag for attaching to a beverage container to allow a drinker or others to identify the ownership of the container. The identification tag includes a tag body made of a thin strip of a flexible material for wrapping around a beverage container. The beverage container identification tag also includes a display area for placement of identifying indicia, such as a name or other symbol. One end of the tag body carries a tacky adhesive, which is used to connect that end to a selected overlapped location on the tag body after it is wrapped snugly around a beverage container. The disclosed identification band is intended to be adjusted at least one time to fit the perimeter of a beverage container, within a given range of circumferences. The Groth invention suffers from the same limitations as that in the Solon disclosure. The ready disposable nature of both the Groth and Solon inventions are not a desirable feature for a container identification means and method for identifying a container personal to a visually impaired individual. Further, the tacky adhesive used to connect the ends of the identification tag is not meant to resist repeated washes in a dishwasher.

Lang, U.S. Pat. No. 5,799,815, discloses a sleeve member that slides over a soda or beer can tab that includes marking indicia to allow one to identify their can from others. This device suffers from a drawback as it is only capable of use with drinks in containers with pull tabs such as soda and beer cans. The vast majority of containers used by infants and the visually-impaired and requiring personal identification do not have pull tabs. Therefore, Lang's invention does not meet the needs described herein.

Shaefer, et al., U.S. Pat. No. 5,992,892, discloses a promotional game for metal cans which includes ink jet printed indicia of winning status on the exterior surface of the can and an opaque removable material covering the printing. Although a container labeling invention is disclosed, it is not amenable to raised face embossing necessary for reading by individuals who are visually impaired. Further, it is designed for one-time use since it is permanently printed onto the surface of the container, preferably a beer or soft drink can.

Kesselring; et al., U.S. Pat. No. 6,082,030, discloses an identifier tag for identifying the owner of a beverage can having a beverage can top equipped with a lever tab. Like Lang, this device suffers from a drawback as it is only capable of use with drinks in containers with pull tabs such as soda and beer cans. The vast majority of containers used by infants and the visually-impaired and requiring personal identification do not have pull tabs. Therefore, the Kesselring, et al. invention does not meet the needs described herein.

Shrader, U.S. Pat. No. 6,412,632, discloses a personal identification method and system for identifying a beverage, food product, or the like, with a particular person. Identifying indicia such as numbers or alphabetical letters are selectable and conditioned by the user to be prominently displayed on the item to identify it with a particular individual. The Shrader invention prevents the unauthorized access to a beverage or food container by means of a pre-selectable code known only to the user. Shrader is not amenable to economical labeling of containers and suffers from the limitation of meeting needs not portended by the invention herein. The invention here is not meant to prevent the unauthorized access to a container.

Kraus, U.S. Pat. No. 6,510,988 discloses an identification bracelet suitable for use by persons with special needs. The bracelet consists of an identification tag built into a wearer resistant squeeze-and-turn buckle. Information about a wearer of such a buckle is typically accessed by means of a computerized system. Therefore, in Kraus, immediate personal identification and that individual's special needs are dependent on non-visual methods and one's ability to access the computer system containing the relevant information. It is not amenable to use the visually impaired.

Bunkers, U.S. Pat. Appl. 20040195254, discloses a flexible composite band consisting of at least two layers of material to identify an individual's drinking container. The first layer is a flexible layer generally constructed from elastic. The second layer is a decorative layer that can be customized to suite one's tastes and is attached directly to the elastic layer. Once this composite flexible identification band is formed it can be placed around drinking containers of various sizes and shapes and allow for easy identification of a drinking container due to the unique decorative layer. The Bunkers disclosure has the limitation that it must be fabricated of at least two layers. The Bunkers invention requires a two-step manufacturing process and suffers from the potential disengagement of the elastic and cloth layers thereby potentially reducing its useful life, especially under the stress of repeated washes in a home dishwasher. Further, it may be difficult, if not impossible, to emboss the cloth layer with the raised dots required for reading by the visually impaired.

Luedde, U.S. Pat. Appl. 20040128877, discloses a beverage container identification method, system, and device consisting of an elastomeric band displaying a unique identifying indicia allowing for application of the band to a beverage container. The system comprises a means for engaging an outer surface of the container, and means for displaying, opposite the means for engaging of the elastic compressive force, a specific identifying indicia. Although similar to the disclosure herein, the Luedde invention does not disclose or claim its use for visually-impaired individuals, and as such, it is limited to sighted persons.

Harris, U.S. Pat. Appl. 20040206828, discloses identification devices for infant articles and methods thereof. An identification device for an infant comprises a receiver member having a recess for receiving a label. A tightly fitting retainer encloses the label in the recess of the receiver member. The label comprises visual information to identify the infant, including the infant's name, address, parent's names, and current history of immunizations, medications and emergency telephone numbers, a photograph of the infant, a finger print and a toe print. The information may also be embedded in electronic form or as bar coded data coupled to the identification device. The identification device may be coupled to a portion of an infant's body including an arm or a leg and to an infant's possession's including drink and eating containers, apparel, foot wear, cribs and strollers. The Harris invention has the same limitations as the Evans, U.S. Pat. No. 5,358,770, invention. It appears difficult to transport to and from a location without a separate container due to its bulky nature. Further, the semi-circular ring is not designed to completely surround the container to which it is affixed. It therefore will not fix itself securely to containers of a shape different than the shape of the semi-circular ring. The Harris invention, like Evans, suffers from the limitation that each identifying device must be pre-designed and pre-manufactured to fit the shape and circumference of the container it is to surround.

### BRIEF SUMMARY OF THE INVENTION

The present invention is a device, system and method whereby an elastomeric band, embossed or debossed on its outer surface with alphanumeric characters and embossed with braille characters on its outer surface denoting an individual's first, middle, or last name, or one or more of them, the contents of the container, or any other information useful to the owner, possessor, or user of the container, surrounds the container to be labeled, such that elastomeric forces cause the inner surface of the band to fit snugly around the outer surface of the container. The inside of the elastomeric band may or may not be debossed with any number of alphanumeric characters to identify place of manufacture, manufacturer's name, or any other information useful to the manufacturer, distributor, or user.

The elastomeric band is fabricated of materials known to those skilled in the arts of elastomeric material selection which give it the properties of durability, water resistance, thermal sterilizability, microwaveability, flexibility, strength, limited elastomeric tensile force such that an individual with ordinary levels of finger and hand strength and dexterity may stretch it to a circumference slightly larger than the circumference of the container to be labeled, sufficient elastomeric compressive force such that when stretched and placed around a container of suitable circumference and then released, it will fit tightly around the container, and sufficient thickness to permit embossing or debossing on the inside and outside surfaces. The elastomeric band is preferably located along the length of the container at or near its midpoint. However, depending on the specific container, the elastomeric band may be located at any point along the length of the container.

The inside circumference of the elastomeric band is sized to be slightly less than the outside perimeter of the container to be labeled. Being slightly smaller in circumference than the container it is designed to surround, the identification band must be stretched to some degree by hand to slip it over the container. Once the elastomeric band is released, compressive force causes it to surround the container with sufficient tightness to maintain its position in spite of handling or washing.

When the container is empty or no longer desired to be labeled, the elastomeric identification band may be removed by stretching it slightly by hand until its inside circumference exceeds the outside perimeter of the container it surrounds. The band may then be lifted longitudinally towards and over the top or bottom of the container. Once removed, the container may be dealt with as desired by the user.

After the elastomeric band is removed, it may be immediately placed around another container of suitable circumference, or stored for the same use later. There is no need to discard it if it has not been damaged or otherwise rendered unuseable; as say by ordinary wear and tear.

The possibilities for embossing alphanumeric and braille characters on the outer surface and debossing alphanumeric characters on the inside are endless. The invention described herein is not limited to names. Any alphanumeric or braille word or phrase may be embossed on the inner or outer surfaces of the elastomeric band and still fall within the description herein.

### BRIEF DESCRIPTION OF THE SEVERAL VIEWS OF THE DRAWINGS

(1) Drawing Figures

FIG. 1 illustrates an elastomeric identification band surrounding a baby's or infant's drinking cup with the name, “GRANT” in alphanumeric characters.

FIG. 2 shows an elastomeric identification band surrounding a shampoo bottle embossed on the outer surface with braille dots signifying the name, Grant.

FIG. 3 depicts an isomeric view of the elastomeric identification band showing the raised faces of the embossing depicting the word, GRANT, in alphanumeric and braille characters on the outer surface and debossing showing the phrase, MADE IN THE USA, on the inner surface.

FIG. 4 shows the identification band around an irregularly shaped container, such as a bottle of household cleaner.

FIG. 5 depicts a section view of the identification band around and irregularly shaped container, showing its ability to assume the shape of such container.

### DETAILED DESCRIPTION OF THE PREFERRED EMBODIMENT

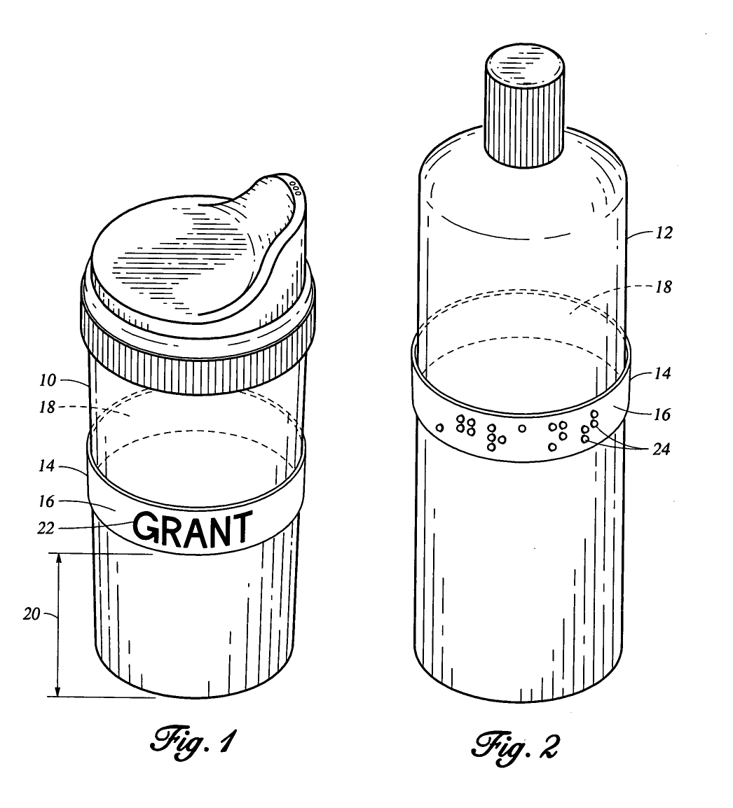

Referring to FIG. 1, a container 10, a member of the group of containers used for holding liquid food stuffs, comprises a baby bottle (for example, for containing milk, soda, juice or other beverages suitable for the feeding of infants and which is well known to those of ordinary skill in the art). FIG. 2 shows a container 12, a member of the group of containers used for holding or storing any flowable liquid or solid, comprising a shampoo bottle.

In FIG. 1, surrounding container 10 is an elastomeric band 14, the subject of the invention herein, with inside circumference sufficient to snugly encircle item 10 and suitable outside circumference to result in ample thickness to permit embossing on the outer surface 16 and debossing on the inner surface 18 and to resist breakage by hand stretching. The elastomeric band is made of materials known to those of ordinary skill in the art of elastomeric material selection which has sufficient elastomeric tensile strength to resist tearing when stretched by hand and sufficient elastomeric compressive stress to fit the receiving container snugly when placed in position 20 around container 10. Position 20 is but one of any number of positions where band 14 might be placed.

Referring to FIG. 1, radial forces directed towards the longitudinal center line of container 10 by elastic compressive forces within item 14 cause 14 to fit snugly around 10. Once band 14 is released, the radial forces directed toward the longitudinal center line of item 10 and the frictional forces arising between inner surface 18 and outer surface of item 10, cause band 14 to remain in place.

On outer surface 16 of 14, is a group of alphanumeric characters 22 which serve as a specific identifying indicia to precisely identify container 10 from other containers in the group of similar containers. The other containers in the group (not shown) are surrounded by other bands which also have specific identifying indicia; however, the specific identifying indicia on the other containers are different from the specific identifying indicia embossed on item 14 surrounding container 10.

Referring to FIG. 2, in the preferred embodiment, on outer surface 16 of band 14 surrounding item 12, is a group of braille characters 24 embossed on outer surface 16 at some preselected position relative to alphanumeric characters 22. In this embodiment, the braille characters, item 24, represent the braille translation of the word or words depicted by alphanumeric characters 22. In the preferred embodiment, items 22 and 24 are an individual's name, which precisely identify that container as belonging to that particular individual.

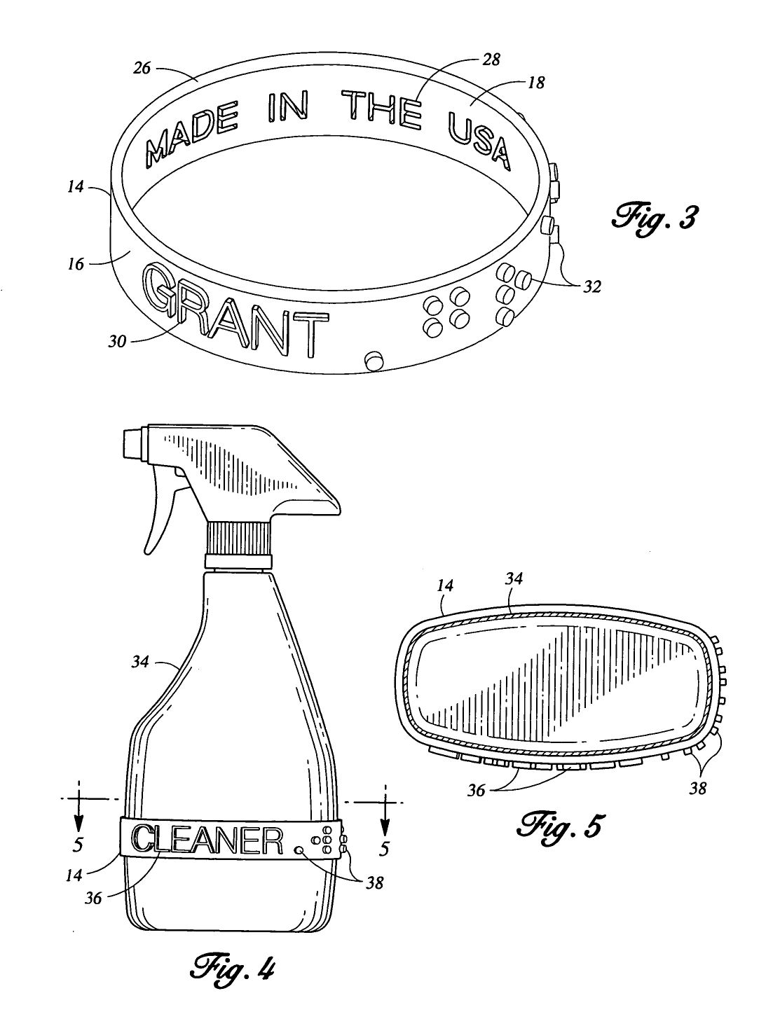

FIG. 3 shows an isometric view of a complete band 14. It depicts 14 as being constructed of one continuous monolithic piece of elastomeric material with sufficient thickness, 26, to allow embossing or debossing of the inner surface, 18, and outer surface, 16. The inner surface of band 14, item 18, depicted in FIG. 3 is debossed with the phrase, MADE IN THE USA, item 28. The outer surface, item 16, is embossed with the name, GRANT, item 30, and the braille representation for GRANT, item 32, adjacent to it.

FIG. 4 shows band 14, in place and surrounding an odd-shaped container, 34. FIG. 4 depicts the flexibility of band 14, which allows it to encircle a container of odd shape known to those skilled in the arts of manufacturing containers for commercial or domestic use. Those skilled in the arts in the properties of elastomeric bands will know that the elastomer will assume the shape of the container it surrounds, even those of irregular shape like item 34 depicted in FIG. 4. Further, such individuals skilled in the arts of fabricating elastomeric bands will readily see that the inside rest circumference of the band, 14, must be slightly less than the circumference of item 34, regardless of the profile of item 34, for 14 to remain in place after it has been placed in the desired longitudinal position on container 34.

The outer surface of band 14, item 16, depicted in FIG. 4, is embossed with the word, CLEANER, item 36, and the braille representation for the same word adjacent to it, item 38. Thus, FIG. 4 depicts the invention, without limitation, being used to label household items with both alphanumeric and braille characters.

FIG. 5 shows a section of item 34 adjacent to the position where band 14 is positioned around 14. FIG. 5 depicts that the invention disclosed here readily assumes the shape of the container it surrounds, even a container of irregular shape like item 34 depicted in FIG. 4. The raised faces of the embossed word, CLEANER, item 36, and the braille representation for the same word adjacent to it, item 38, are shown.

In further embodiments, the embossed or debossed identifying indicia, items 22, 24, 28, 30, 32, 36 or 38 of band 14, comprise various colors, the colors being different than the color of band 14. For example, without limitation, band 14 may be white, and the embossed or debossed alphanumeric or raised braille dots may be the color “green” to signify to a sighted person a container containing a liquid or powder safe for ingestion, “yellow” to identify a container containing a material safe for older children, but not babies or infants, or “red” to distinguish a dangerous material. The contrasting colors described herein will assist the sighted person in quickly associating a container with a particular individual or a container containing a dangerous or hazardous material.

In still further embodiments, the identifying indicia, items 22, 24, 28, 30, 32, 36 or 38 of band 14, comprise a combination of symbols (for example, alphanumeric characters) and colors. Further examples of identifying indicia (including, without limitation, bar-codes, data matrices, etc.) will occur to those of skill in the art.

The above embodiments have been given by way of example only. Further examples will occur to those of skill in the art without departing from the spirit of the invention.

I claim:

1. A device for identification of a container, the device comprising;
(A) a container encircling means wherein said container encircling means comprises an inner surface and an outer surface and an at rest inner circumference and an at rest outer circumference;
(B) an outer label means on said outer surface of the container encircling means;
(C) an inner label means on said inner surface of the container encircling means; and
(D) a place holding means wherein the container encircling means retains its position once placed around the container.

2. A device as in claim 1, wherein the:
(A) said container encircling means is a flexible band, wherein said flexible band is;
(1) a ring of outside diameter greater than its height formed from a water resistant, thermally sterilizable, and microwaveable elastomeric material;
(2) said ring having an inner surface and an outer surface;
(3) the ring further comprising an at rest inner circumference and an at rest outer circumference wherein the difference between said at rest outer circumference and said at rest inner circumference gives the ring a thickness enough to permit an outer label means to be debossed onto said outer surface and an inner label means to be debossed onto said inner surface at the same radial locations without exceeding said thickness of the flexible band and a tensile strength sufficient to permit the ring to be stretched to a new inner circumference approximately twice the at rest inner circumference without breakage;
(B) said outer label means is a plurality of alphanumeric characters embossed or debossed onto the outer surface of the flexible band or a plurality of braille characters embossed onto the outer surface of the flexible band, which when read together, comprise the name or identity of the user, owner or possessor of the container, the contents of the container, or any other information which may be expressed by said alphanumeric characters or said braille characters;
(C) said inner label means is a plurality of alphanumeric characters embossed or debossed onto the inner surface of the flexible band or a plurality of braille characters embossed onto the inner surface of the flexible band, which when read together, comprise the name or identity of the user, owner or possessor of the container, the contents of the container, or any other information which may be expressed by the alphanumeric characters or the braille characters; and
(D) said place holding means is a frictional force between the ring and the container sufficient to outweigh the gravitational force acting on the ring, wherein said frictional force is caused to be sufficient by the at rest inner circumference of the ring being less than the outer circumference of the container where the ring is brought to rest around the container.

3. A device as in claim 1, wherein the:
(A) said container encircling means is a flexible band, wherein said flexible band is;
(1) a ring of outside diameter greater than its height formed from a natural or synthetic polymer intended for repeated use, water resistant, thermally sterilizable, microwaveable, and generally recognized as safe for use in food or food packaging;
(2) said ring having an inner surface and an outer surface;
(3) the ring further comprising an at rest inner circumference and an at rest outer circumference wherein the difference between said at rest outer circumference and said at rest inner circumference gives the ring a thickness enough to permit an outer label means to be debossed onto said outer surface and an inner label means to be debossed onto said inner surface at the same radial locations without exceeding said thickness of the flexible band and a tensile strength sufficient to permit the ring to be stretched to a new inner circumference approximately twice the at rest inner circumference without breakage;
(B) said outer label means is a plurality of alphanumeric characters embossed or debossed onto the outer surface of the flexible band or a plurality of braille characters embossed onto the outer surface of the flexible band, which when read together, comprise the name or identity of the user, owner or possessor of the container, the contents of the container, or any other information which may be expressed by said alphanumeric characters or said braille characters;
(C) said inner label means is a plurality of alphanumeric characters embossed or debossed onto the inner surface of the flexible band or a plurality of braille characters embossed onto the inner surface of the flexible band, which when read together, comprise the name or identity of the user, owner or possessor of the container, the contents of the container, or any other information which may be expressed by the alphanumeric characters or the braille characters; and
(D) said place holding means is a frictional force between the ring and the container sufficient to outweigh the gravitational force acting on the ring, wherein said frictional force is caused to be sufficient by the at rest inner circumference of the ring being less than the outer circumference of the container where the ring is brought to rest around the container.

4. A device as in claim 1, wherein the:
(A) said container encircling means is a flexible band, wherein said flexible band is;
(1) a ring of outside diameter greater than its height formed from a water resistant, thermally sterilizable, and microwaveable elastomeric material;
(2) said ring having an inner surface and an outer surface;
(3) the ring further comprising an at rest inner circumference and an at rest outer circumference wherein the difference between said at rest outer circumference and said at rest inner circumference gives the ring a thickness enough to permit an outer label means to be debossed onto said outer surface and an inner label means to be debossed onto said inner surface at the same radial locations without exceeding said thickness of the flexible band and a tensile strength sufficient to permit the ring to be stretched to a new inner circumference approximately twice the at rest inner circumference without breakage;
(B) said outer label means is a plurality of alphanumeric characters embossed or debossed onto the outer surface of the flexible band and a plurality of braille characters embossed onto the outer surface of the flexible band, which when read together, comprise the name or identity of the user, owner or possessor of the container, the contents of the container, or any other information which may be expressed by said alphanumeric characters or said braille characters;
(C) said inner label means is a plurality of alphanumeric characters embossed or debossed onto the inner surface of the flexible band and a plurality of braille characters embossed onto the inner surface of the flexible band, which when read together, comprise the name or identity of the user, owner or possessor of the container, the contents of the container, or any other information which may be expressed by the alphanumeric characters or the braille characters; and
(D) said place holding means is a frictional force between the ring and the container sufficient to outweigh the gravitational force acting on the ring, wherein said frictional force is caused to be sufficient by the at rest inner circumference of the ring being less than the outer circumference of the container where the ring is brought to rest around the container.

5. A device as in claim 1, wherein the:
(A) said container encircling means is a flexible band, wherein said flexible band is;
(1) a ring having an inner surface and an outer surface;
(2) said ring comprising an inside diameter greater than an inner height of the ring, said inner height being measured at said inner surface, and an outside diameter greater than an outer height, said outer height being measured at said outer surface, formed from a natural or synthetic polymer intended for repeated use, water resistant, thermally sterilizable, microwaveable, and generally recognized as safe for use in food or food packaging;
(3) the ring further comprising an at rest inner circumference and an at rest outer circumference wherein the difference between said at rest outer circumference and said at rest inner circumference gives the ring a thickness enough to permit an outer label means to be debossed onto said outer surface and an inner label means to be debossed onto said inner surface at the same radial locations without exceeding said thickness of the flexible band and a tensile strength sufficient to permit the ring to be stretched to a new inner circumference approximately twice the at rest inner circumference without breakage;
(B) said outer label means is a plurality of alphanumeric characters embossed or debossed onto the outer surface of the flexible band and a plurality of braille characters embossed onto the outer surface of the flexible band, which when read together, comprise the name or identity of the user, owner or possessor of the container, the contents of the container, or any other information which may be expressed by said alphanumeric characters and said braille characters;
(C) said inner label means is a plurality of alphanumeric characters embossed or debossed onto the inner surface of the flexible band and a plurality of braille characters embossed onto the inner surface of the flexible band, which when read together, comprise the name or identity of the user, owner or possessor of the container, the contents of the container, or any other information which may be expressed by the alphanumeric characters and the braille characters; and
(D) said place holding means is a frictional force between the ring and the container sufficient to outweigh the gravitational force acting on the ring, wherein said frictional force is caused to be sufficient by the at rest inner circumference of the ring being less than the outer circumference of the container where the ring is brought to rest around the container.

6. A method for labeling a container, comprising the steps of:
(A) placing said container in a position to accept a container encircling means;
(B) selecting said container encircling means whereby;
(1) the container encircling means has an inner surface and an outer surface, an inner circumference slightly smaller than an outer circumference of the container at the point where the container encircling means is to be located around the container;
(2) the container encircling means has imprinted on said outer surface an outer label means;
(3) the container encircling means has imprinted on said inner surface an inner label means;
(C) confirming that said outer label means contains information which a sighted person or a visually-impaired person intends to use to describe the ownership or possession of the container, the contents of the container, or any other information known to said sighted person or said visually-impaired person;
(D) confirming that said inner label means contains information which the sighted person or the visually-impaired person intends to use to describe the ownership or possession of the container, the contents of the container, or any other information known to the sighted person or the visually-impaired person;
(E) grasping the container encircling means by both hands of the sighted person or both hands of the visually-paired person;
(F) extending both hands of the sighted person or both hands of the visually-impaired person while maintaining a grip on the container encircling means to enlarge the container encircling means to a new inner circumference slightly larger than the outer circumference of the container;
(G) positioning the container encircling means over the container and close to the proximate center-line of the container;
(H) selecting a point on the container where the sighted person or the visually-impaired person wants to place the container encircling means around the container;
(I) lowering or raising the container encircling means to said point on the container;
(J) stopping movement of the container encircling means lateral to the longitudinal center-line of the container at the point where the sighted person or the visually-impaired person wants to place the container encircling means around the container; and
(K) releasing the grasp of the container encircling means by the sighted person or the visually-impaired person.

7. A method for labeling a container as in claim 6, wherein the:
(A) said container encircling means is a flexible band, wherein said flexible band is;
(1) a ring of outside diameter greater than its height formed from a water resistant, thermally sterilizable, and microwaveable elastomeric material;
(2) said ring having an inner surface and an outer surface;
(3) the ring further comprising an at rest inner circumference and an at rest outer circumference wherein the difference between said at rest outer circumference and said at rest inner circumference gives the ring a thickness enough to permit an outer label means to be debossed onto said outer surface and an inner label means to be debossed onto said inner surface at the same radial locations without exceeding said thickness of the flexible band and a tensile strength sufficient to permit the ring to be stretched to a new inner circumference approximately twice the at rest inner circumference without breakage;
(B) said outer label means is a plurality of alphanumeric characters embossed or debossed onto the outer surface of the flexible band or a plurality of braille characters embossed onto the outer surface of the flexible band, which when read together, comprise the name or identity of the user, owner or possessor of the container, the contents of the container, or any other information which may be expressed by said alphanumeric characters or said braille characters; and
(C) said inner label means is a plurality of alphanumeric characters embossed or debossed onto the inner surface of the flexible band or a plurality of braille characters embossed onto the inner surface of the flexible band, which when read together, comprise the name or identity of the user, owner or possessor of the container, the contents of the container, or any other information which may be expressed by the alphanumeric characters or the braille characters.

8. A method for labeling a container as in claim 6, wherein the:
(A) said container encircling means is a flexible band, wherein said flexible band is;
(1) a ring of outside diameter greater than its height formed from a natural or synthetic polymer intended for repeated use, water resistant, thermally sterilizable, microwaveable, and generally recognized as safe for use in food or food packaging;
(2) said ring having an inner surface and an outer surface;
(3) the ring further comprising an at rest inner circumference and an at rest outer circumference wherein the difference between said at rest outer circumference and said at rest inner circumference gives the ring a thickness enough to permit an outer label means to be debossed onto said outer surface and an inner label means to be debossed onto said inner surface at the same radial locations without exceeding said thickness of the flexible band and a tensile strength sufficient to permit the ring to be stretched to a new inner circumference approximately twice the at rest inner circumference without breakage;
(B) said outer label means is a plurality of alphanumeric characters embossed or debossed onto the outer surface of the flexible band or a plurality of braille characters embossed onto the outer surface of the flexible band, which when read together, comprise the name or identity of the user, owner or possessor of the container, the contents of the container, or any other information which may be expressed by said alphanumeric characters or said braille characters; and
(C) said inner label means is a plurality of alphanumeric characters embossed or debossed onto the inner surface of the flexible band or a plurality of braille characters embossed onto the inner surface of the flexible band, which when read together, comprise the name or identity of the user, owner or possessor of the container, the contents of the container, or any other information which may be expressed by the alphanumeric characters or the braille characters.

9. A method for labeling a container as in claim 6, wherein the:
(A) said container encircling means is a flexible band, wherein said flexible band is;
(1) a ring of outside diameter greater than its height formed from a water resistant, thermally sterilizable, and microwaveable elastomeric material;
(2) said ring having an inner surface and an outer surface;
(3) the ring further comprising an at rest inner circumference and an at rest outer circumference wherein the difference between said at rest outer circumference and said at rest inner circumference gives the ring a thickness enough to permit an outer label means to be debossed onto said outer surface and an inner label means to be debossed onto said inner surface at the same radial locations without exceeding said thickness of the flexible band and a tensile strength sufficient to permit the ring to be stretched to a new inner circumference approximately twice the at rest inner circumference without breakage;
(B) said outer label means is a plurality of alphanumeric characters embossed or debossed onto the outer surface of the flexible band and a plurality of braille characters embossed onto the outer surface of the flexible band, which when read together, comprise the name or identity of the user, owner or possessor of the container, the contents of the container, or any other information which may be expressed by said alphanumeric characters or said braille characters; and
(C) said inner label means is a plurality of alphanumeric characters embossed or debossed onto the inner surface of the flexible band and a plurality of braille characters embossed onto the inner surface of the flexible band, which when read together, comprise the name or identity of the user, owner or possessor of the container, the contents of the container, or any other information which may be expressed by the alphanumeric characters or the braille characters.

10. A method for labeling a container as in claim 6, wherein the:
(A) said container encircling means is a flexible band, wherein said flexible band is;
(1) a ring having an inner surface and an outer surface;
(2) said ring comprising an inside diameter greater than an inner height of the ring, said inner height being measured at said inner surface, and an outside diameter greater than an outer height, said outer height being measured at said outer surface, formed from a natural or synthetic polymer intended for repeated use, water resistant, thermally sterilizable, microwaveable, and generally recognized as safe for use in food or food packaging;
(3) the ring further comprising an at rest inner circumference and an at rest outer circumference wherein the difference between said at rest outer circumference and said at rest inner circumference gives the ring a thickness enough to permit an outer label means to be debossed onto said outer surface and an inner label means to be debossed onto said inner surface at the same radial locations without exceeding said thickness of the flexible band and a tensile strength sufficient to permit the ring to be stretched to a new inner circumference approximately twice the at rest inner circumference without breakage;
(B) said outer label means is a plurality of alphanumeric characters embossed or debossed onto the outer surface of the flexible band and a plurality of braille characters embossed onto the outer surface of the flexible band, which when read together, comprise the name or identity of the user, owner or possessor of the container, the contents of the container, or any other information which may be expressed by said alphanumeric characters and said braille characters; and
(C) said inner label means is a plurality of alphanumeric characters embossed or debossed onto the inner surface of the flexible band and a plurality of braille characters embossed onto the inner surface of the flexible band, which when read together, comprise the name or identity of the user, owner or possessor of the container, the contents of the container, or any other information which may be expressed by the alphanumeric characters and the braille characters.

11. A device for identification of a container, the device comprising;
(A) a container encircling means, wherein said container encircling means is a flexible band, wherein said flexible band is;
(1) a ring having an inner surface and an outer surface;
(2) said ring comprising an inside diameter greater than an inner height of the ring, said inner height being measured at said inner surface, and an outside diameter greater than an outer height, said outer height being measured at said outer surface, formed from a natural or synthetic polymer intended for repeated use, water resistant, thermally sterilizable, microwaveable, and generally recognized as safe for use in food or food packaging;
(3) the ring further comprising an at rest inner circumference and an at rest outer circumference wherein the difference between said at rest outer circumference and said at rest inner circumference gives the ring a thickness enough to permit an outer label means to be debossed onto said outer surface and an inner label means to be debossed onto said inner surface at the same radial locations without exceeding said thickness of the flexible band and a tensile strength sufficient to permit the ring to be stretched to a new inner circumference approximately twice the at rest inner circumference without breakage;
(B) said outer label means is a plurality of alphanumeric characters embossed or debossed onto the outer surface of the flexible band and a plurality of braille characters embossed onto the outer surface of the flexible band, which when read together, comprise the name or identity of the owner of the container, the contents of the container, or any other information which may be expressed by said alphanumeric characters and said braille characters;
(C) said inner label means is a plurality of alphanumeric characters embossed or debossed onto the inner surface of the flexible band and a plurality of braille characters embossed onto the inner surface of the flexible band, which when read together, comprise the name or identity of the owner of the container, the contents of the container, or any other information which may be expressed by the alphanumeric characters and the braille characters; and
(D) a place holding means, wherein said place holding means comprises a frictional force between the ring and the container sufficient to outweigh the gravitational force acting on the ring, wherein said frictional force is caused to be sufficient by the at rest inner circumference of the ring being less than the outer circumference of the container where the ring is brought to rest around the container.
